(19) United States
(12) Patent Application Publication
(10) Pub. No.: US 2013/0122449 A1
(43) Pub. Date: May 16, 2013

(54) Even impact reducing implement for dental applications

(71) Applicant: Arthur Kitchings Weathers, JR., Scottsdale, AZ (US)

(72) Inventor: Arthur Kitchings Weathers, JR., Scottsdale, AZ (US)

(21) Appl. No.: 13/373,370

(22) Filed: Nov. 14, 2011

(51) Int. Cl. A61C 19/00

(52) U.S. Cl. 433/25

(57) ABSTRACT

Fluid distributions implement to evenly wear down dental decay, diseased tissue, or undesired dentin in oral applications with live patients. The dentist has adjustable control over both the intensity and distribution field of a low-pressure sterile fluid, which may contain a pre-determined amount of reductive elements held in suspension. The implement must be supplied with a source of power and feed line of the chosen fluid. When switched on, it delivers one or a plurality of rapid bursts of varying impact strength in such a quick manner that the entire impact zone receives an even distribution of the liquid bursts. The desired result is the severe reduction in cratering, gouging, and non-symmetrical damage introduced by implements of the prior art such as drills, jet-stream fluid delivery systems, and tissue sanders with less danger of structural impairment to the patient in these cases of comparison.

### BACKGROUND OF THE INVENTION

The invention is intended as a dental fluid distribution implement with the ability to evenly wear down tooth decay, diseased tissue, or undesired dentin in oral applications with live patients. It delivers one or a plurality of rapid fluid bursts of varying impact strength in such a manner that the entire impact zone receives an even distribution. The dentist has adjustable control over both the intensity and distribution field of the low-pressure sterile fluid, which may contain a pre-determined amount of reductive elements held in suspension. The desired result is the severe reduction in cratering, gouging, and non-symmetrical damage introduced by implements of the prior art such as drills, jet-stream fluid delivery systems, and tissue sanders with less danger of structural impairment to the patient in these cases of comparison.

The treatment of dental caries in all manner of decay possibilities is done with the objective of removing undesired layers of active decay, minimizing future bacterial intrusions, and filling the excavated site with appropriate fillings. Unfortunately, dentists employing the accepted method of high-speed drilling will inevitably and consistently remove far more undamaged dentin than is desirable. Secondly, they will introduce by the very nature of drill action a layer of potential bacterial corruption called the smear zone. This is where the rotating and grinding of the drill tip ceases to dig further, leaving a rough landscape which dentists must attempt to polish away. The prior art of mechanically drilling away caries and tooth structure is extensive, and not similar to the instant invention.

The use of abrasive air or fluid driven methodology to resolve medical problems is centered on anatomical features undergoing gross exposure to reducing substances flung against them. An example would be Molinari's U.S. Pat. No. 5,037,432 (1991) which can remove human skin or tissue by superficial abrasion. An example specific to dentistry would be Mabille's U.S. Pat. No. 4,676,749 (1987) for cleaning teeth.

The use of a high pressure fluid in the form of a jet stream to achieve medical resolutions is seen in Campbell's U.S. Pat. No. 5,620,414 (1997). This entails the use of a hydraulic ram to compress a collapsible bag of sterile fluid inside an implosion chamber, which ultimately generates an extremely high pressure jet of water suitable to effectively cut human tissue. A water shroud around the jet stream is cited to enclose the tissue impact zone in a manner to contain flying/rebounding water and detached cellular material from leaving the impact zone. A drawback to the shroud is it obstructs the view of the operator of the impact zone. An example specific to the dental industry would be Hood et al.'s U.S. Pat. No. 6,497,572 (2002) which also uses a highly pressurized jet of fluid to pulverize tissue for removal by aspiration. In their Summary of the Present Invention Hood et al. teach that the pressure of the jet water is between 500-60,000 psi and the jet stream orifice is only 10-800 microns. Hood et al allege that the orifice can pass pure fluids and even abrasive solutions if so desired to precipitate emulsification or cutting of soft (but not hard) tissue. This makes it powerless in cavity removal. Their invention is “ . . . limited in its ability to cut or erode the hard calcified tooth tissue.” To protect the patient due to the potentially dangerous high pressure jet involving improper pressure, there is a need for a bubble detector to stop the intensification of pressure as fast as is mechanically possible.

Kutch et al. U.S. Pat. No. 5,601,430 (1997) is a dental repair process for treatment of dental caries. A fluid jet of air, which may be augmented with fluid, directs abrasive particles against a chosen surface.

Concerning the use of liquid jet streams, a relevant major issue jumps out: Whether carrying reductive elements or not, the force of impact against dental structure is concentrated in the center, with less proportional force the further from this center that is measured. Thus a direct stream or a pulsed stream both deliver a disproportionate force as measured from the center of impact. With hand operation, the center of the stream will be constantly moving chaotically, together with the weaker forces radiating from the center. Although capable in the example of cleaning surfaces, neither type of stream is optimal for evenly wearing away dental structures in the zone hit by the fluid, which in its entirety is termed the impact zone. Thus in these examples the outer edge of the impact zone (relative to the center) is not removed with a similar depth. This is because any jet, even those carrying reducing elements, by its nature digs a curved-wall crater rather than a flat and round pill box style excavation.

### SUMMARY OF THE INVENTION

It is an objective of the instant invention to provide a dental implement capable of delivering one or a plurality of circularly-moving timed-release bursts of fluid against dental structure with the objective to reduce all of said structure in an even fashion within the impact zone, such that the reduction has a diameter roughly equal to the diameter of the collective whole of the timed-release bursts and a uniform depth across the entire impact zone.

It is another objective of the instant invention to provide a dental implement capable of delivering low-pressure levels below 500 psi sufficient to eliminate the use of a water shroud or other obstruction to allow a dentist to constantly visually evaluate the progress of the operation.

It is another objective of the instant invention to provide a dental implement capable of low-pressure levels below 500 psi sufficient to eliminate the use of a bubble detector manufactured for patient safety.

It is another objective of the instant invention to provide a dental implement that is not limited in its ability to erode hard calcified tooth tissue.

It is another objective of the instant invention to provide a dental implement capable of significantly reducing the generation of cratering and smear zone regions as engendered by procedures to remove dental structure within a field of operation (such as encompassed by entire dental decay cavity), where the field diameter is much wider and larger than the momentary impact zone of a prior art drill or liquid jet.

It is another objective of the instant invention to provide a dental implement capable of significantly reducing the elevated patient discomfort offered by prior art drilling techniques, and reducing the need for needle-injection deadening of nerve responses to prevent or lower such discomfort.

### BRIEF DESCRIPTION OF THE DRAWINGS

FIG. 1 is a microburst emitter (1) with an interior chamber (2) for fluid containment that can be pressurized. It is shown snap-fit attached to the regions near a one-way inlet valve (20) of a fluid-delivery anchor stem (10).

FIG. 2 is a partial view of the anterior end of microburst emitter (1) showing the axis (27) around which it spins while delivering a plurality of fluid microbursts (25) to a chosen dental surface (26).

FIG. 3 shows the circular impact zone within which the plurality of microbursts will strike when no wobble is present. This is with a very slow spin rate and an embodiment firing six evenly spaced microbursts around the circumference. Surface splash-back is high.

FIG. 4 shows the elongation effect on a single fluid microburst (25) as the spin rate is increased to sixteen cycles per second.

FIG. 5 shows a circular impact zone where the spin rate is sixteen cycles per second, and the elongation effect is enacted. Surface splash-back is greatly reduced and inundation coverage is increased.

FIG. 6 is an improved version of the outcome seen in FIG. 5 where the circumference unit (CU) is increased to twelve divisions. The thirteenth microburst will line back up again with the first.

FIG. 7 is an optimized version of the outcome seen in FIG. 6. The CU unit is increased to nineteen. The microburst discharge rate is set to release after twenty two CU's are traversed. The first microburst set (36) lands at the starting position, the second set (37) strikes after twenty two CU's have been traversed, etc. This continues until the twentieth firing again synchronizes back on top of the original set (36) at the starting position.

FIG. 8 shows a cross section through both emitter (1) and anchor stem (10) as seen in FIG. 1 through dashed line (14). The cross section view goes down deep enough to include bearing (23) and its path around stem (10).

FIG. 9 shows the bearing (23) movement relative to the emitter's (1) inner rim as was depicted in FIG. 8. The five spin lines (31, 32, 33, 34, 35) earlier depicted in FIGS. 3 and 5 are superimposed for teaching purposes to calculate the induced wobble.

FIG. 10 is a side view of the tilt induced when bearing (23) is passing through the N position. This depicted side view of emitter (1) and bearing (23) is what would be visually observed from the W position.

FIG. 11 shows the effect of the induced wobble on the impact zone by superimposing the impact zone coverage chart of FIG. 7 with the results on the same impact zone when the tilt is as depicted in FIG. 10.

FIG. 12 shows a view of the tilt as observed from the S position when bearing (23) is at the W position. Rotational axis (44) has now reached its greatest angle of deviation from the reference axis (27).

FIG. 13 shows the effect of the induced wobble on the impact zone by superimposing the impact zone coverage chart of FIG. 7 with the results on the same impact zone when the tilt is as depicted in FIG. 12. Movement of bearing (23) to the W position has greatly extended the fluid elongation effect within the entire impact zone.

FIG. 14 is a mirror image of FIG. 10. The view is from the W position. It shows the tilt induced when bearing (23) is at the S position. Emitter (1) is lifted towards the S position, so the tilt of axis (44) is towards the N position.

FIG. 15 is a mirror image of FIG. 11. It shows the effect of the induced wobble on the impact zone by superimposing the impact zone coverage chart of FIG. 7 with the results on the same impact zone when the tilt is as depicted in FIG. 14. The real-world superimposing of the four coverage patterns as detailed in FIGS. 7, 11, 13, and 15 results in sufficient coverage of the impact zone as contemplated for the preferred embodiment.

FIG. 16 is a cross section blow up of the coupling mechanism between emitter (1) and upper reaches of anchor stem (10).

FIG. 17 is a view down into the delivery end of emitter (1) showing the line of exit-ports (22) as previously depicted in FIG. 1.

FIG. 18 also shows a view down into the delivery end of emitter (1). The preferred embodiment arrangement of exit-ports is depicted.

FIG. 19 shows a cross section of an embodiment capable of a precise control of the circumference speed for bearing (23).

FIG. 20 is a superimposed composite of the inner bull's eye ring formed with the superimposed coverage charts shown in FIGS. 7, 11, 13, and 15.

FIG. 21 is a depiction of the entire impact zone shown in FIG. 20 with the intercrossed lines of all the four rings remove for visual clarity. In theory designated area (72) is not struck by microbursts.

FIG. 22 is a cross section of an embodiment similar to that of FIG. 9 where inner ring (31) has been replaced with the composite landing pattern shown in FIG. 20. Bearing (23) follows a perfectly circular path around the outer dimensions of anchor stem (10).

FIG. 23 is a cross section of an embodiment similar to that in FIG. 22 in which the shape of anchor stem (10) defines an ellipse rather than a circle.

FIG. 24 is an alternate embodiment in which the lower rim of emitter (1) is not being directed by a bearing, but rather by a variable strength polarized magnetic field generator (74) part of and contiguous with anchor stem (10). A polarized magnetic receptor (77) is repulsed or attracted on command.

FIG. 25 is an alternate embodiment without offset axis displacement.

### DETAILED DESCRIPTION OF THE INVENTION

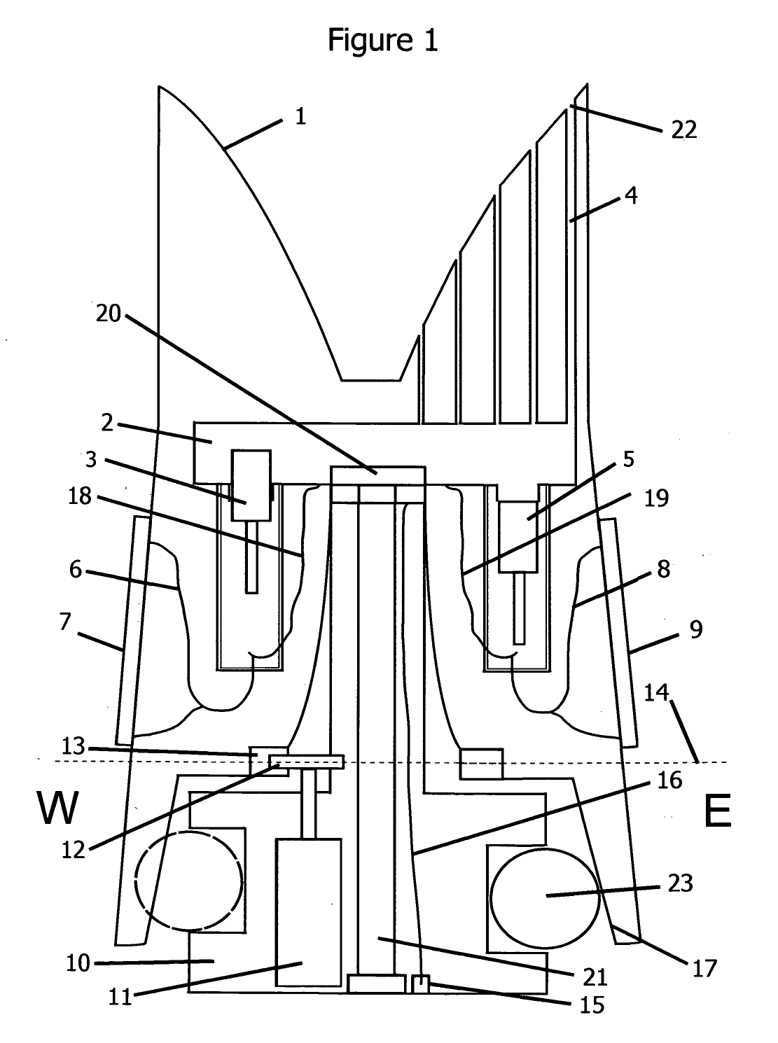

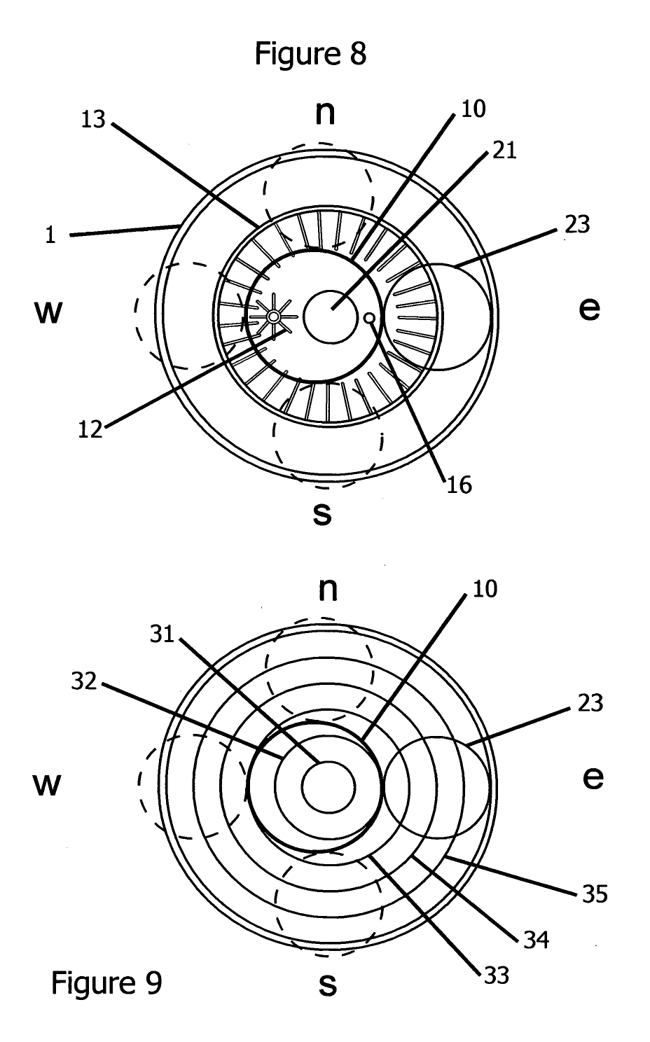

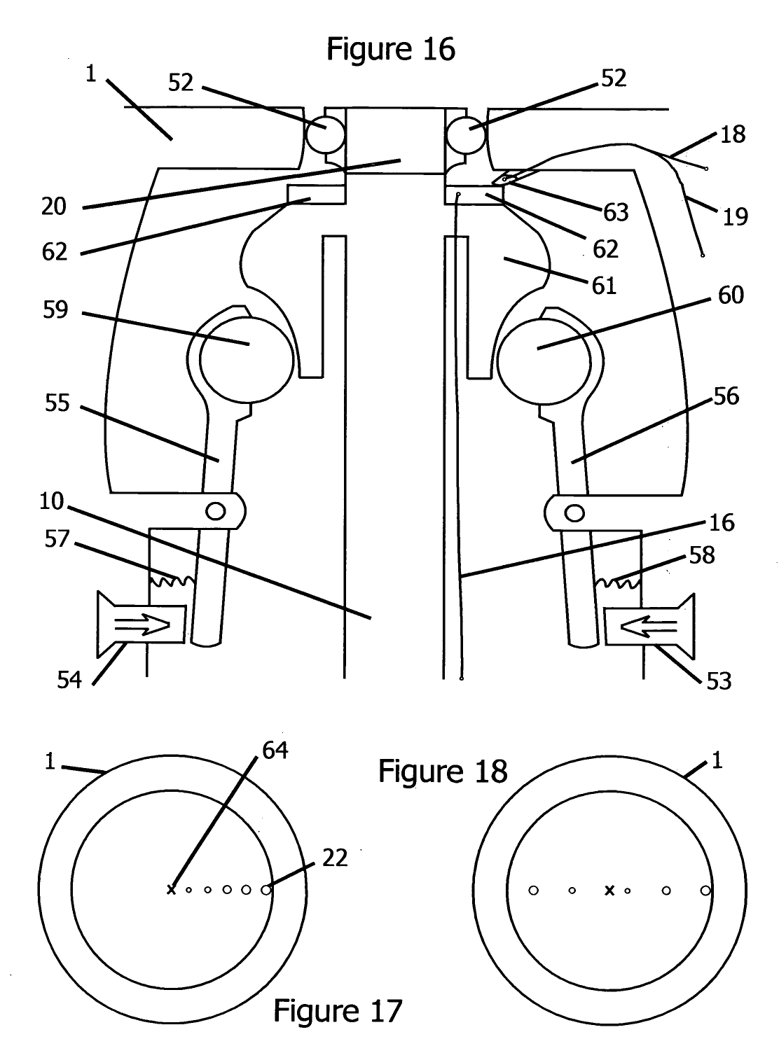

FIG. 1 is a side view of the somewhat cone-shaped microburst emitter (1) with an interior chamber (2) for fluid containment. When pressure is increased inside chamber (2) by the ramming action of a pair of motor-driven plungers (3, 5), lengthened fluid bursts are ejected from a plurality of exit-ports (22) via escape tubes (4) in a manner similar to torpedoes leaving a submarine. The lengthening of each tube (4) and a diameter increase (the further from the center) allows more fluidic mass to pass. Ganged control of the speed of the alternating plungers (3, 5) is operator controlled through electrical wire (6) by slider (7), and ganged control of the extension distance (which controls inside pressure magnitude) of the alternating plungers (3, 5) is operator controlled through electrical wire (8) by slider (9). Emitter (1) is driven to spin around anchor stem (10) by propulsion motor (11) using flywheel (12) to turn gear (13), all shown in profile. Horizontal hashed line (14) establishes a plane through which FIG. 8 can show the propulsion from another perspective. Electrical connector (15) allows electrical power to move through wire (16) to the rotation assembly around one-way fluid inlet valve (20) for connection to ganged wires (18, 19) of spinning emitter (1) as can be seen in greater detail in FIG. 16. One-way inlet valve (20) allows chamber (2) to be refilled by low pressure fluid traveling up tube (21) when the inner pressure is in a drop-low suction cycle. Inlet valve (20) also blocks return of fluid back into tube (21) when chamber (2) is in a pressurized state. The defined path of the fluid microbursts leaving exit-ports (22) as emitter (1) is spinning can be altered by a controlled wobble induced by a round bearing (23) rapidly moving around anchor stem (10) in a looping path of defined deviations. There is no rim deviation when bearing (23) passes through the E position. For greater understanding, bearing (23) is shown in dashed line view when passing through the W position, where it inflicts the greatest amount of wobble deviation pushing outward against the indented surface (17) of the lower rim of emitter (1) as it spins. Note that when bearing (23) reaches the W position, it is physically elevated further up anchor stem (10) than it is in the E position. This elevation is designed to smooth out the rotational speed of bearing (23) when orbiting anchor stem (10).

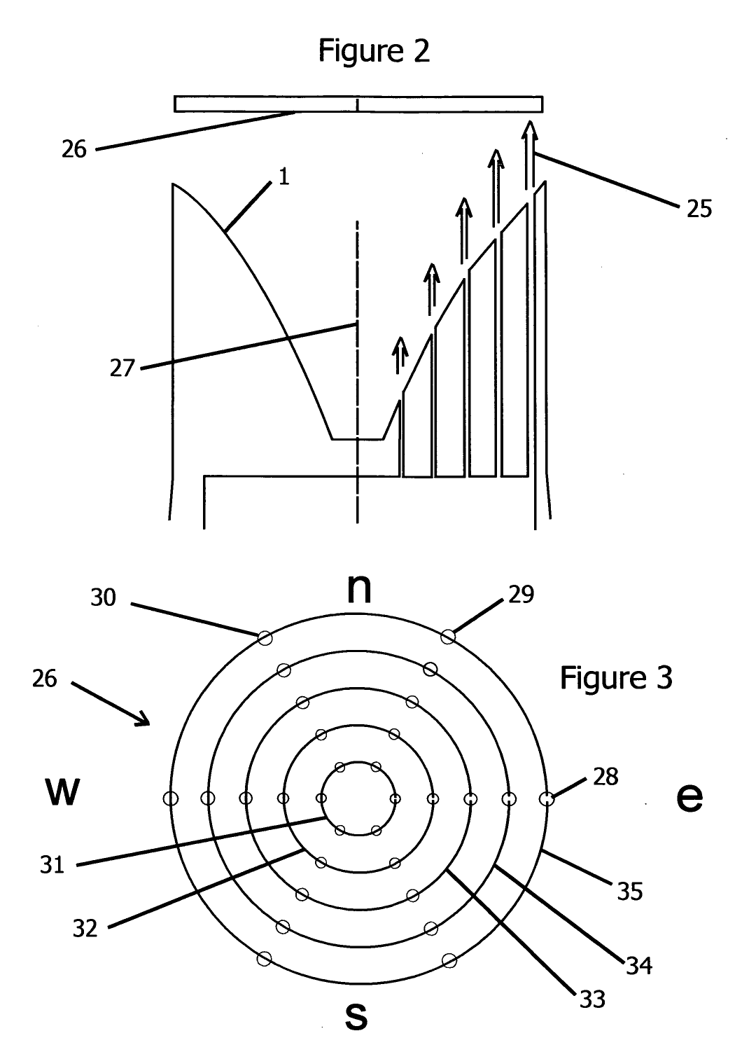

FIG. 2 is a partial view blow-up of the anterior end of emitter (1) showing the exit trajectories of fluid microbursts (25) as they leave emitter (1) on a path to strike dental surface (26). Without an induced wobble, emitter (1) spins evenly around axis (27).

FIG. 3 shows the circular impact zone within which the plurality of microbursts (25) will strike dental surface (26) when no wobble is present. For teaching purposes, the impact zone can be divided into a defined number of portions, which are termed circumference units (CU). With a circumference unit of six as depicted, a spin rate slowed down to one cycle (six CU's) per second, and a microburst rate of seven CU's, results can be evaluated. After the first microburst set (28) lands at the E position, the second set (29) will strike after seven CU's have been traversed. This continues until the seventh firing would synchronize back on top of the original set (28) in the E position. Because in this example the spin is extremely slow, each microburst set hits within the impact zone with little spreading along the five spin lines (31, 32, 33, 34, 35). Surface splash-back is high. This is a non-desirable outcome, because geometrically the fluid sets strike a tiny portion of the entire impact zone.

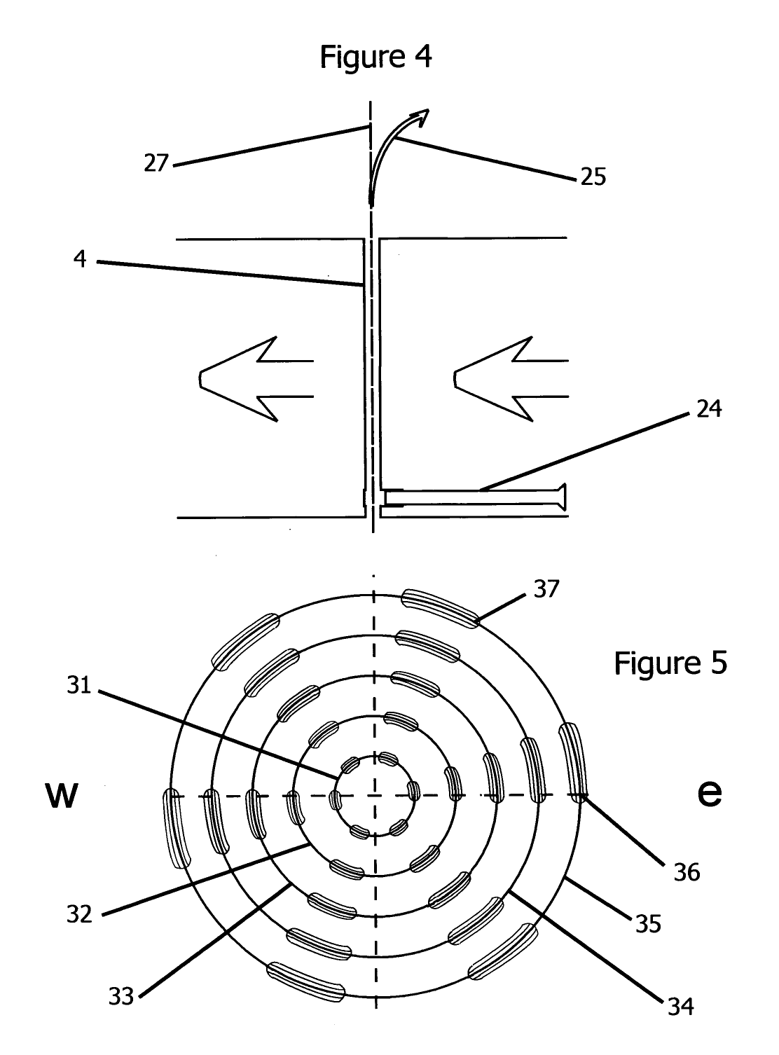

FIG. 4 shows a bending effect on a single fluid microburst (25) as the spin rate is increased to sixteen cycles per second. The view of emitter (1) is from on edge through the plurality of tubes (4) and through the axis line (27) around which the spin movement occurs. With the spin counterclockwise each microburst in the set curves like a banana in the clockwise direction. This causes a fluid elongation effect when the microburst strikes the impact zone. When fluid pressure is greatly increased at the opening of tube (4), the fluid inside tube (4) is ejected outwards as though by detonation. As the magnified pressure inside the delivery chamber flattens, the resistance of the inner walls of tube (4) grows larger and creates a snapping effect that marks the tail of microburst (25). By the time tube (4) is refilled pressure is rapidly dropping inside the compression chamber and ejection of fluid is at a momentary end. The pressure of fluid within the compression chamber is always greater than the outside air pressure (which is about 15 psi at sea level) and keeps air from backfilling into tube (4). Careful regulation of the length to diameter ratio of the associated tube (4) versus the values of other tubes in a plurality can assist in perfecting a desired length for a particular fluid microburst (25) giving each a defined volume relative to others. Tube (4) can be closed by a locking plunger (24) that the dentist can activate in or out with the purpose to narrow the diameter of the impact zone, for example as the dental cavity undergoing reduction grows smaller in diameter and mass.

FIG. 5 is similar to FIG. 3 in that it shows a CU division of six with a firing of fluid microbursts every seven CU's traversed. However, because the spin rate is increased to sixteen cycles per second, the elongation effect is now occurring. Again, the first microburst set (36) lands at the starting position, the second set (37) strikes after seven CU's have been traversed. This continues until the seventh firing again synchronizes back on top of the original set (36) at the starting position. Geometrically more of the impact zone is covered and splash-back is minimized, yet there is little merit in the overall distribution of fluid.

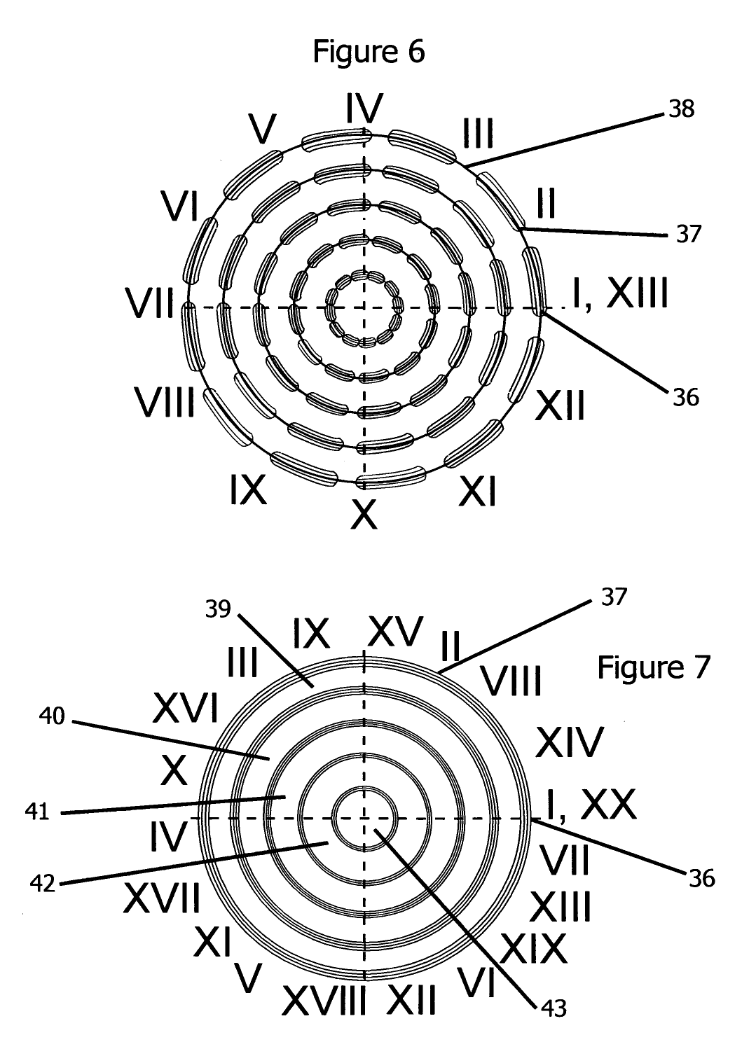

FIG. 6 is an improved version of the outcome seen in FIG. 5. The spin cycle is still at sixteen revolutions per second, and the CU unit is increased to twelve. With a discharge rate of the microbursts set to thirteen CU's, the first microburst set (36) lands at the starting position, the second set (37) strikes after thirteen CU's have been traversed. This continues until the thirteenth firing again synchronizes back on top of the original set (36) at the starting position. Geometrically even much more of the impact zone is covered, yet there are still gaps (38) within the circular paths defining the impact zone. For teaching purposes, the series of microburst landing sites have a roman numeral placed in close proximity in sequential order.

FIG. 7 is an optimized version of the outcome seen in FIG. 6. The spin cycle is still at sixteen revolutions per second, and the CU unit is increased to nineteen. With a discharge rate of the microbursts set to twenty two CU's, the first microburst set (36) lands at the starting position, the second set (37) strikes after twenty two CU's have been traversed. This continues until the twentieth firing again synchronizes back on top of the original set (36) at the starting position. Geometrically evaluated, all of the circular routes of the plurality of microbursts defining the impact zone are struck, yet there are still large gaps (39, 40, 41, 42, 43) between the circular paths defining the impact zone that are not struck. An introduced wobble to the emitter's axis can fill in these five gaps.

FIG. 8 shows a cross section through both emitter (1) and anchor stem (10) as seen in FIG. 1 through dashed line (14). The cross section is broad enough to include bearing (23) and its path around anchor stem (10), whose outer circumference is darker to emphasize the offset to the spin axis which would pass directly through the center of the fluid delivery tube (21). Tube (21), electrical wire (16), and the propulsion motor's flywheel (12) are the only contents of anchor stem (10). As flywheel (12) turns, blades of gear (13) engage and set emitter (1) spinning in a perfect circle. The long blades of gear (13) are rigid enough to allow the tines of flywheel (12) to move them, but flexible enough to bend and let the driving tines of flywheel (12) spin uselessly if emitter (1) momentarily hits oral structure such as a tongue or tooth by accident. By design, bearing (23) when at the E position maintains physical contact with the spinning inner edge of emitter (1). For example, with a counterclockwise spin the contact will initiate bearing (23) into moving counterclockwise in such a manner that bearing (23) begins to push the rim outwards, a process that reaches a maximum deflection at the W position. (For visual clarity flywheel (12) and gear (13) are shown in FIG. 1 and FIG. 8 in close proximity to the bearing's route. Actually they are both much higher up the anchor stem and near the top of the emitter cone.)

FIG. 9 shows the contemplated movement of bearing (23) relative to the emitter's (1) inner rim as was depicted in FIG. 8. However, the flywheel assembly is not shown and the five spin lines (31, 32, 33, 34, 35) earlier depicted in FIG. 5 are superimposed for teaching purposes. The radius of circular spin line (31), which resembles a bull's eye of an archery target, has a length of BR, which is a proportional distance derived from the bull's eye radius. BR also is the distance separating all the other spin rings. Thus, the proper outwards deflection of the emitter's (1) inner edge at position N is one half of BR, at position W is equal to BR, at position S is again one half of BR, and down to zero BR at starting position E where no deflection is induced. The diameter of bearing (23) is 4.000 BR. By design the center of anchor stem (10) is located in the W direction by a distance of 1.000 BR as measured from the center of inner circular spin line (31). Since the circular path of bearing (23) must roll against the outer surface of anchor stem (10), and stem (10) is fashioned at a distance of one BR in the W direction, then it follows that because the inside edge of emitter (1) naturally spins around an axis passing through the direct center of inner ring (31) that bearing (23) will force the inside edge of emitter (1) to tilt out by a distance of one BR when it reaches the W position, which forces the spin axis of the entire emitter (1) to smoothly re-locate to the center of the circle defined by anchor stem (10).

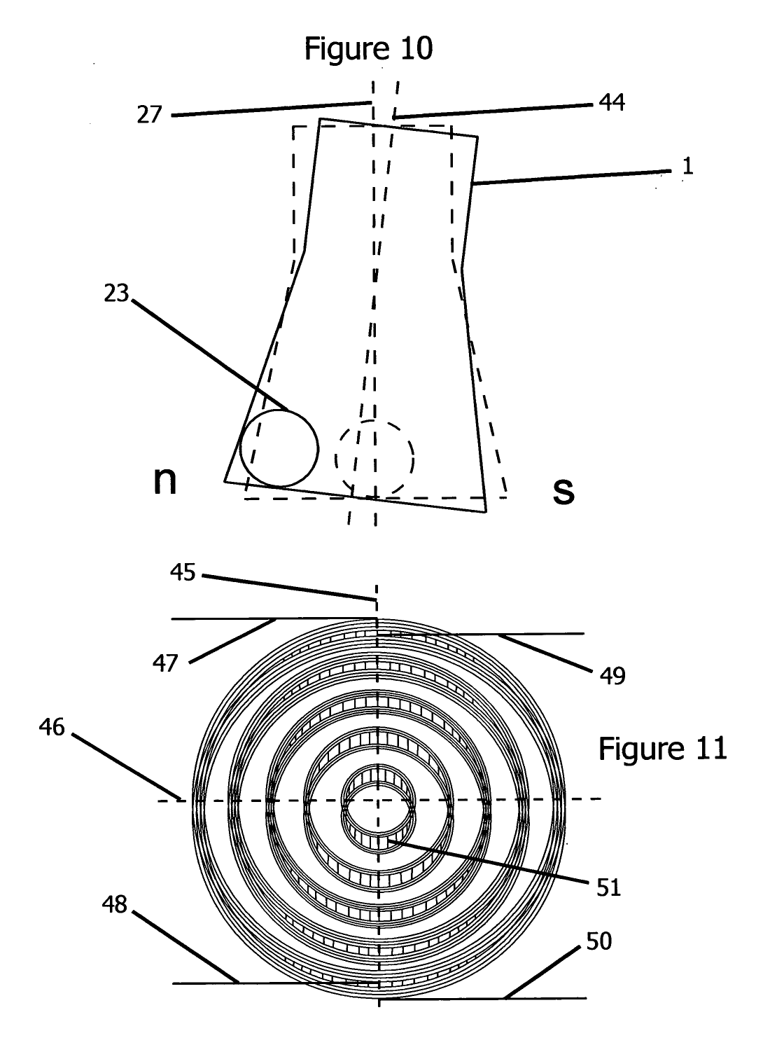

FIG. 10 is a side view of the tilt induced when bearing (23) is passing through the N position. Note that the depicted side view of emitter (1) and bearing (23) is what would be visually observed from the W position. Rotational axis (27) is centered when bearing (23) is in the E position, and the outline of emitter (1) and bearing (23) are shown with hashed lines to display their lack of tilt at that stage. Rotational axis (44) defines the amount of induced tilt from vertical as measured from axis (27).

FIG. 11 shows the effect of the induced wobble on the impact zone by superimposing the impact zone coverage chart of FIG. 7 with the results on the same impact zone when the tilt is as depicted in FIG. 10. Since the inner edge of emitter (1) is lifted in the N position, the deflection of rotational axis (44) has caused the landing rings to move in the S direction. The initial E position impact zone has a center defined by vertical line (45) and horizontal line (46). The outer boundary lines (47, 48) show the non-tilted extent of coverage. Outer boundary lines (49, 50) show the wider extent of coverage with bearing (23) at the N position. Linking lines (51) between the circles are an artificial visual construct to fill in the path of fluid coverage as bearing (23) moves counterclockwise through one fourth of its route from the E position to the N position. As compared to the fluid coverage seen in FIG. 7, movement of bearing (23) to the N position has extended the fluid elongation effect within the entire impact zone.

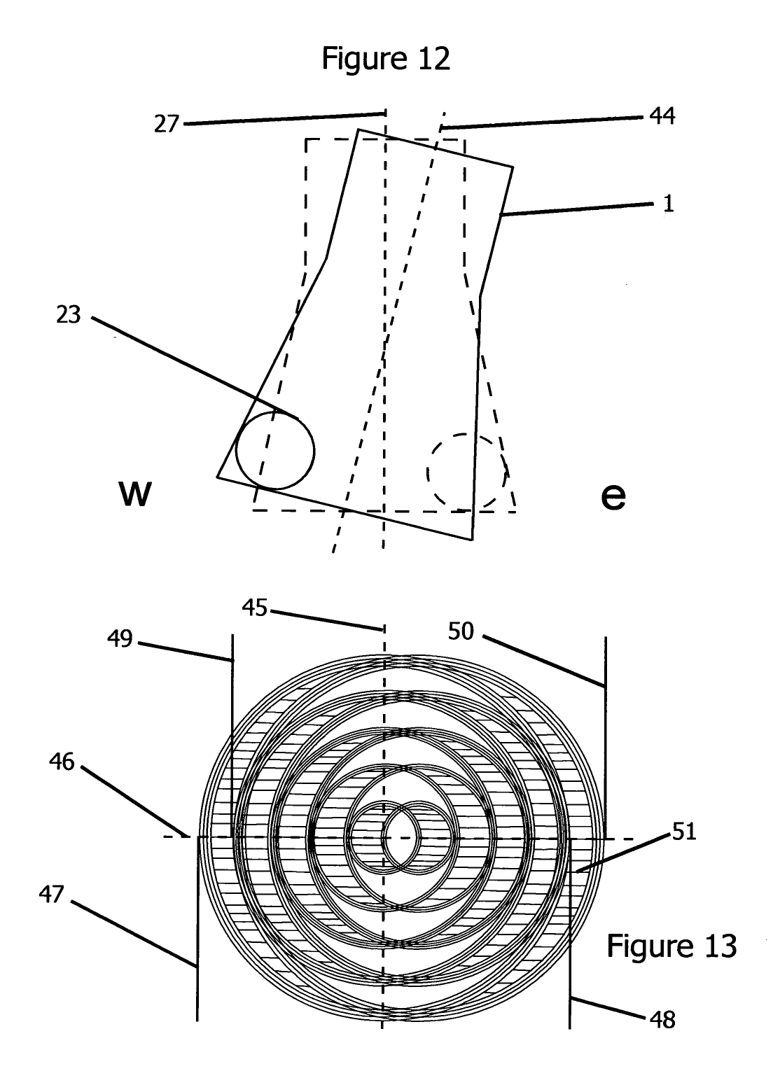

FIG. 12 shows a view of the tilt as observed from the S position when bearing (23) is at the W position. As in FIG. 10, emitter (1) and bearing (23) are shown with dashed lines representing the non-tilted state at the E position. Rotational axis (44) has now reached its greatest angle of deviation from the reference axis (27).

FIG. 13 shows the effect of the induced wobble on the impact zone by superimposing the impact zone coverage chart of FIG. 7 with the results on the same impact zone when the tilt is as depicted in FIG. 12. Since the inner edge of emitter (1) is lifted in the W position, the deflection of rotational axis (44) has caused the landing rings to move in the E direction. The initial E position impact zone has a center defined by vertical line (45) and horizontal line (46). The outer boundary lines (47, 48) show the non-tilted extent of coverage. Outer boundary lines (49, 50) show the wider extent of coverage with bearing (23) at the W position. Linking lines (51) between the circles are a visual construct to fill in the path of fluid coverage as bearing (23) moves through one half of its route from the E position to the W position. (For visual clarity, the deviation of the impact zone coverage depicted in FIG. 11 is not superimposed onto this drawing.) As compared to the fluid coverage seen in FIG. 7, movement of bearing (23) to the W position has greatly extended the fluid elongation effect within the entire impact zone.

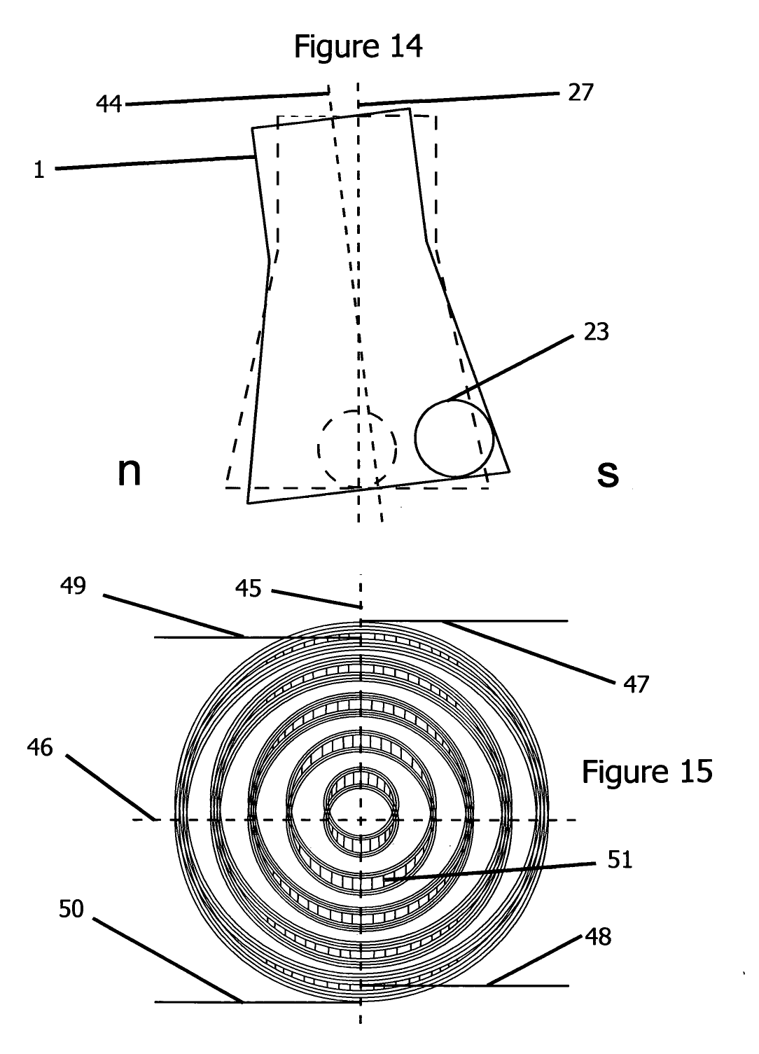

FIG. 14 is a mirror image of FIG. 10. As there, the view is from the W position. It shows the tilt induced when bearing (23) is at the S position. The lower edge of emitter (1) is lifted towards the S position, so the tilt of axis (44) is towards the N position.

FIG. 15 is a mirror image of FIG. 11. It shows the effect of the induced wobble on the impact zone by superimposing the impact zone coverage chart of FIG. 7 with the results on the same impact zone when the tilt is as depicted in FIG. 14. Since the inner edge of emitter (1) is lifted in the S position, the deflection of rotational axis (44) has caused the landing rings to move in the N direction. As compared to the fluid coverage seen in FIG. 7, movement of bearing (23) to the S position has extended the fluid elongation effect within the entire impact zone. A composite illustration (not shown) superimposing FIGS. 7, 11, 13, and 15 with the vertical and horizontal lines (45, 46) all aligned would be one continuous blanket of coverage within the expanded impact zone. For all practical purposes, there is complete inundation of a targeted area. This fluid distribution methodology with a completed wobble circuit culminates in the desired outcome of the instant invention.

FIG. 16 is a cross section blow up of the coupling mechanism between emitter (1) and upper reaches of anchor stem (10). One-way fluid inlet valve (20) allows fluid to escape into the pressure chamber (not shown) when pressure is reduced inside of the chamber, and prevents backflow when pressure in the chamber is elevated. Surrounding inlet valve (20) is an O-ring (52) about which emitter (1) spins. O-ring (52) is a fluid barrier that stops leakage. When worn down from usage, a dentist can close a pin-head set of pliers (not shown) to constrict locking pins (53, 54) inward, which action causes see-saw bars (55, 56) to move against the springs (57, 58) and flip back the two spin bearings (59, 60) sufficiently wide that they both can pass upwards around the rounded guide-bulge (61) and thus decouple the two parts. The rounded guide-bulge (61) is a physical part of anchor stem (10) and in use keeps emitter (1) from being detached from anchor stem (10) as well as giving spin bearings (59, 60) a guide path to spin around as emitter (1) itself is spinning. Electricity is carried up wire (16) to a circular round conductive contact surface (62) resting at the top of guide-bulge (61). A circulating conductive terminal (63) sweeps around contact surface (62) to keep a steady supply of power to emitter (1). Conductive wires (18, 19) carry power to the two (not shown) ganged motor-driven plungers (3, 5) seen in FIG. 1. Since the need for power is small (less than 4 volts DC would be a typical value) a charged battery (not shown) placed along the outer surface of emitter (1) would eliminate the need for an outside power source to supply the motors. However, most dentists prefer a steady source of power that will not quit in the middle of a procedure.

FIG. 17 is a view down into the delivery end of emitter (1) showing the line of exit-ports (22) as previously depicted in FIG. 1. The letter X (64) is not structure but represents the point at which the spin axis passes through emitter (1). This particular arrangement of exit-ports was utilized for easy understanding of the teaching. However, a more lateral distribution of fluid discharge than this embodiment provides is desirable.

FIG. 18 shows the line up of exit-ports of the preferred embodiment. The second and fourth exit-ports (as measured from the center) are moved to; positions juxtaposed away from the others, yet still contained within a straight line drawn through them all. (Increasing the exit-port discharge tube diameters would narrow the un-impacted regions between landing rings, yet also up the mass/width of fluid rings striking the impact zone and thus splash back.)

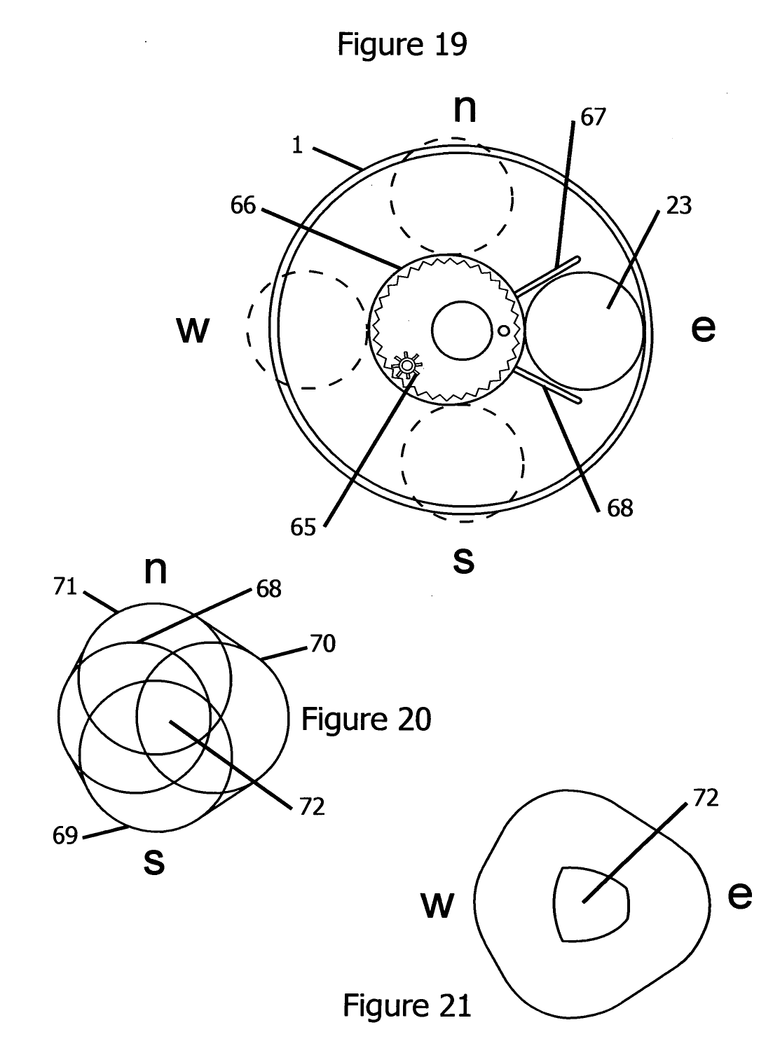

FIG. 19 shows a cross section of an embodiment capable of a precise control of the circumference speed for bearing (23). An additional motor (not shown) drives flywheel (65), which by turning engages the teeth of circular gear (66). Bearing (23) is bracketed by leading arm (67) and trailing arm (68). Depending on need, leading arm (67) can slow down the circumference speed of bearing (23) as induced by the spinning movement of emitter (1) to less than it would else wise attain. Or trailing arm (68) can be sped up to hasten bearing (23) to a greater speed than it would else wise attain. This is termed mechanical shepherding control. Other ways to spin the shepherding arms (67, 68) without flywheel (65) can be employed, such as magnetic polarity repulsion (not shown) or other methodology.

FIG. 20 is a composite of the innermost bull's eye ring shown in FIGS. 7, 11, 13, and 15. For clarity, the four rings are each reduced to a basic circular line not interconnected by linking lines (51). Inner ring (31) first shown in FIGS. 3 and 5 will be termed ring (68) in this drawing as this composite can also be considered as one generated from an embodiment with a single exit-port. At a setting of nineteen CU's, the circular depiction of ring (68) represents the continuous nineteen evenly spaced microbursts peppering the entire circumference of the outer edge of ring (68), with nothing striking the central regions. This circle of impacting fluid is physically moved in a circular wobbled route within the impact zone as bearing (23) (not shown) makes its orbit. From the starting position, ring (69) moves next to the S direction as bearing (23) moves to the N position. Next it moves another fourth of the orbit to the position of ring (70), next to the position of ring (71), and then back to the position of ring (68). The only place within the impact zone that is not struck by the microbursts is within the confines of designated area (72).

FIG. 21 is a depiction of the entire impact zone shown in FIG. 20 with the intercrossed lines of all the four rings remove for visual clarity. In theory, if the patient never moved, or the hand of the dentist guiding the emitter never moved, designated area (72) would not be struck by microbursts. With the spinning emitter (1) shown in FIGS. 1 and 2, the bull's eye ring (31) shown in FIGS. 3 and 5 represents about one fiftieth of the area of the entire impact zone. As seen in this FIG. 21, designated area (72) is about one tenth of the bull's eye's area. In actual practice with a plurality of exit-ports (22) defining the size of a particular impact zone, the tiny overall boundary that encloses designated area (72) does not defeat the intent of the preferred embodiment.

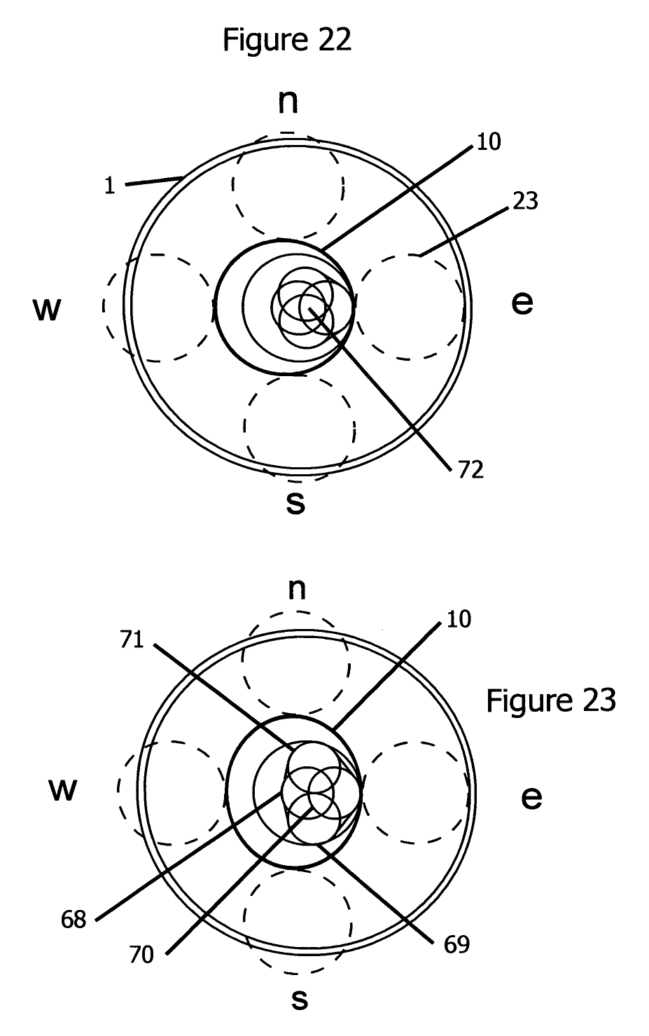

FIG. 22 is a cross section of an embodiment similar to as described in FIG. 9. For teaching purposes in this FIG. 22 drawing, inner ring (31) has been replaced with the impact zone's composite landing pattern shown in FIG. 20. With a basic embodiment with only one exit-port firing, as depicted here, the 90% coverage could be considered less than optimum. Designated area (72) would occupy roughly 10% of the entire impact zone. This is the result when bearing (23) follows a circular path around the likewise circular outer diameter of anchor stem (10), a condition in claiming terminology that is termed “offset circular axis displacement.”

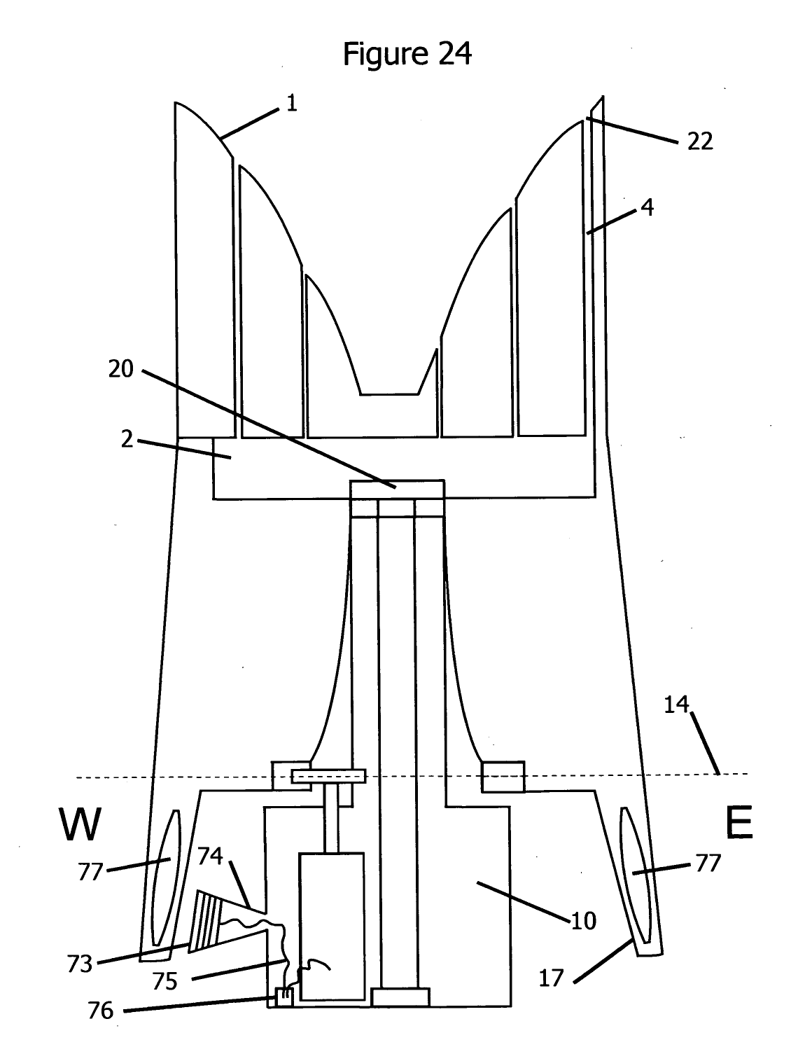

FIG. 23 is a cross section of an embodiment similar to that in FIG. 22 in which the path that bearing (23) follows has been extended outwards to the N direction and the S direction by sufficient curvature to enable bearing (23) to travel further outwards at these locations. The result is the outer dimensions of anchor stem (10) define an ellipse rather than a circle, a condition in claiming terminology that is termed “offset elliptical axis displacement.” The tilting of the inner rim of emitter (1) displays the same amount of tilt when bearing (23) is in the N and S positions as when in the W position. Only the starting E position does not tilt outwards. This embodiment has the four spin rings (68, 69, 70, 71) within the impact zone artificially placed within the illustration for teaching purposes. Spin ring (69) has moved out further to the S position, and spin ring (71) has moved out further to the N position. As a beneficial result, there is no designated area where microbursts do not strike, and there is an effective 100% coverage. However, the use of an elliptical (rather than circular) path for guiding the bearing introduces travel irregularities with an embodiment relying solely on the contact with the rim of emitter (1) to propel bearing (23) around its route. This entails manufacturing complications and extra cost to introduce relief solutions such as mechanical shepherding control as shown in FIG. 19, and explains why the use of an elliptical circumference path for bearing (23) does not replace the use of a circular path as shown in the preferred embodiment. In other words, offset circular axis displacement is preferred over offset elliptical axis displacement.

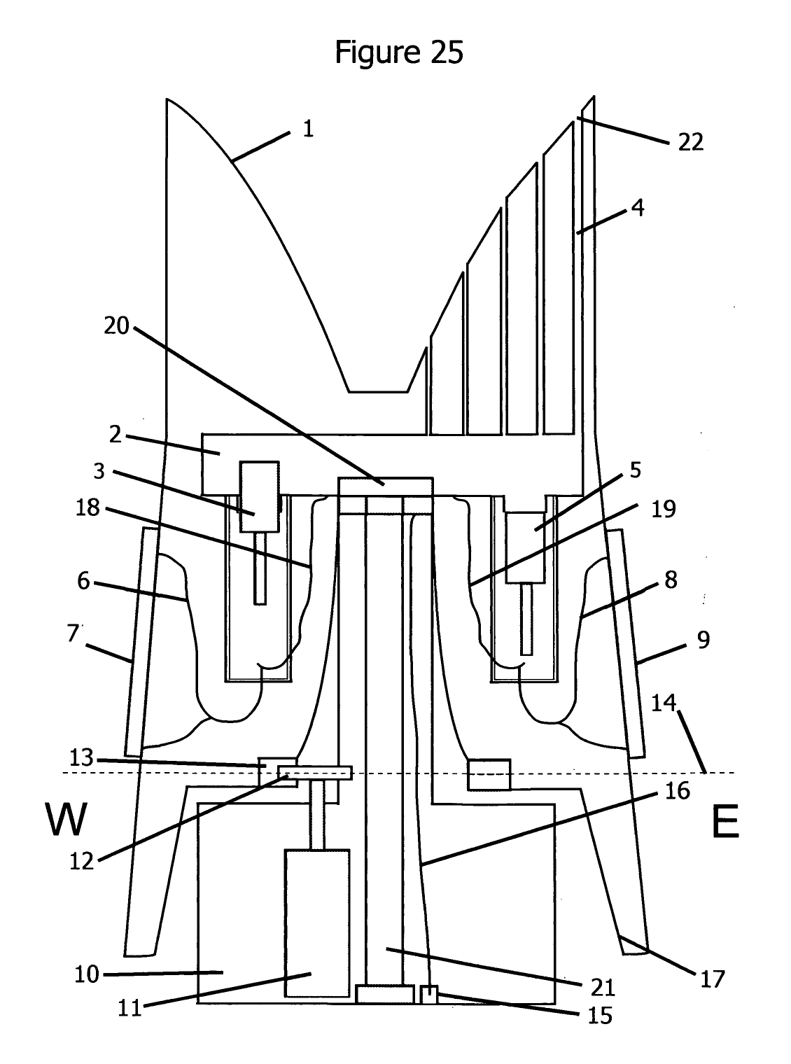

FIG. 24 is an alternate embodiment in which the indented lower rim (17) of emitter (1) is not being pushed outward by a bearing, but rather by a variable strength polarized magnetic field generator (74) part of and contiguous with anchor stem (10). The magnetic end (73) of generator (74) rises in opposing positive value to the lower portion of a negative magnetic band (77) encircling the indented surface of emitter (1), or vice versa. Magnetic end (73) draws power from wire (75) from connector (76). However, field generator (74) is immobile and does not move around anchor stem (10) as did bearing (23). The consequence is that as emitter (1) is spinning and delivering timed fluid microbursts to an impact zone (not shown), the directed magnetic repulsion triggers a movement of the indented surface of emitter (1) outward towards the W direction. This action tilts the entirety of emitter (1) as expected in the W direction which shifts the axis (27) towards the E position in a straight line. This axis deflection causes the microbursts landing within the impact zone to also move more to the E position in a straight line. An abrupt reversal of polarity causes emitter (1) to swing back in a straight line to the starting position shown in the drawing. Thus, the use of magnetic control of the emitter's axis (27) in an alternating high polarity/low polarity cycle produces a temporary straight line deflection path that causes the fluid microburst landing rings to go back and forth in a straight sweeping pattern similar to the pattern depicted in FIG. 13. With for example twenty-eight microburst ejections per second, a typical horizontal sweep pattern would move the impacting circles in the right horizontal direction until a 2.000 BR distance has been covered in three-quarters of a second, followed by a left return to the starting position in another three-quarters of a second. This result realizes the objectives of the instant invention, which is the filling in of the un-hit regions within the impact zone as shown in FIG. 7. Placing a second field generator (not shown) ninety degrees around the circumference of the indented surface of emitter (1) would allow back and forth N to S movements of the entire emitter to happen together with (or separately from) the back and forth E to W direction induced by field generator (74). Controlled push-then-pull movements in the vertical plane together with simultaneous controlled push-then-pull movements in the horizontal plane create a movement pattern for the microburst circle(s) termed “offset V-H axis displacement.” The arrangement of exit-ports (22) depicted in FIG. 18 is implemented in this FIG. 24 embodiment. The exit-ports are better positioned to minimize splash-back. For variation, this embodiment lacks internal pressurization means.

FIG. 25 is an alternate embodiment without offset axis displacement. Smooth sweeping movements by the operator's hand fills in landing gaps.

### SUMMATION

As contemplated by the inventors, neither embodiment of FIG. 24 or FIG. 25 is preferred, but each variation must be claimed for thoroughness.

As recited, the preferred instant invention is a fluid emitter containing internal pressure generating means fitted with mechanical coupling means whereby it can be spun around a central axis for fluid elongation, and also fitted with offset axis displacement means. In the preferred embodiment, this is enabled by locked contact with a fluid and power delivery hand-held mechanism. Thus, an induced movement of one or a plurality of elongated fluid discharges is conveyed in a precise and repeatable manner by the claimed action of offset axis displacement, which is described for the travel patterns defined by circular, elliptical, and V-H embodiments. There are many other travel patterns that can be induced by the instant invention for the path of the spin axis other than the three described travel patterns when designed accordingly. The precise manner in which a series of single elongated microbursts can be selectively and repeatedly moved around within the field of a defined impact zone lies within the described novelty of the instant invention, and is both a novel result unanticipated by the prior art and achieved by use of combined means structure unanticipated by the prior art.

Rather than employing pressure generation within the emitter, bringing an already pressurized flow to the spinning emitter is mechanically feasible, as in shown in FIG. 24. However, this carries the risk that should the coupling means fail, the emitter could be blown off the anchor stem like a flying bullet and seriously harm the patient. Fortunately the instant preferred invention is harmless if detached in use. Despite this, a non-preferred emitter embodiment having fluid elongation means combined with offset axis displacement means defines a functioning basic embodiment using methodology unanticipated by the art, and will be claimed as such.

The removal of an introduced fluid from oral situations is a separate art than that of introducing that fluid. Aspiration has no relevance to this paper.

In the absence of mechanical shepherding control, the movement of bearing (23) around the anchor stem (10) is cited as being propelled by the touching of the emitter's (1) inner rim. The speed of the bearing can be regulated within this situation by either roughening or smoothing the contact surface of the stem (10), the bearing (23), or the emitter rim's inner surface to get a desired revolutions per second. Additionally, the gross weight of bearing (23) can be lightened to speed up its movement to a desired value, or vice versa. A magnetized bearing could be influenced by fields triggered from the anchor stem. As indicated, mechanical shepherding control can hasten or retard the rapidity of bearing (23) around the circumference of its journey with great precision when this is required.

Alternately other ways can be devised to induce a wobble into emitter (1) than with a bearing (23) as described. For example shepherding arms (67, 68) of FIG. 19 could be united and fitted with a magnetic field generator at the tip as utilized in FIG. 24. Therefore this embodiment would use magnetism and the repulsion of the inner rim of emitter (1) to varying fields of reverse polarity to regulate the spin axis position. It differs from the FIG. 24 embodiment in that the controlling magnetism coming from stem (10) spins around inside the rim, and thus the rim would be pushed outwards with a wobble as desired rather than a back and forth sweeping action as described for FIG. 24.

The described flywheel (12) and gear (13) assembly used in FIG. 80 propel the emitter can be replaced by similar magnetic circuits or propulsion technology known to the art that can be configured to regulate the speed of revolutions per second of emitter (1) around anchor stem (10). The term flywheel is chosen for claiming terminology to represent any mechanical controlling means that can impart torque to mechanical receptive means. Similarly the term gear represents any form of mechanical receptive means.

The described use of twin motor-driven plungers (3, 5) is one way to increase and decrease fluid pressure inside a fluid channel or chamber. Other ways would include compression of the fluid channel or chamber dimensions by other displacement actuation means such as piezoelectric or moveable magnetic mass in linear contact with the fluid inside, or one actuation force rather than a plurality, or a plurality of chambers or channels rather than one.

The shape of the chamber (2) is depicted as rectangular, but other shapes such as a straight round channel can be utilized. The placement of tubes (4) channeling the fluid microbursts relative to each other and the emitter's (1) anterior structure is variable, as well as their individual diameter, length, and separation alignments. The angle need not be parallel to the axis.

The tilt angles in the drawings are exaggerated for visual clarity. For instance as shown in FIG. 12 axis (27) and tilt axis (44) if measured are much greater than eight circumference degrees. In other words, the amount of tilt to produce the desired impact zone coverage is slighter than depicted. The depicted embodiment uses a 1.000 BR proportional distance for the maximum deflection in the W position as an aid to teaching. However, by this methodology the flight path may be deviated by an induced wobble to any desired degree by pre-design. For example maximum deflection can be set to 0.333 BR by lessening the diameter and offset magnitude of anchor stem (10) accordingly relative to bearing (23) when in the E position.

The instant invention can be applied to other fields outside that of dentistry, or with other categories within dentistry such as removing tartar, orthodontic adhesive, or old bonding layers for porcelain cap re-fittings, etc.

The foregoing description of the preferred and alternate embodiments of the invention has been presented for purposes of illustration and description. It is not intended to limit the invention to a precise form disclosed, as many modifications without deviating from the spirit and the scope of the invention are possible. The embodiments described are selected to best explain the principles of the invention and its practical application to thereby enable others skilled in the art to best utilize the invention in various ways and with various modifications as suited to the particular purpose contemplated. It is intended that the scope of the invention be defined by the claims appended hereto.

We claim:

1. A fluid emitter with one exit-port or a plurality of exit-ports for external discharge of said fluid directed by said emitter;
said emitter containing variable internal pressure generating means whereby said fluid is increased and decreased in pressure to generate said external discharge of said fluid;
said emitter fitted with spin-revolution receptive means;
said emitter also fitted with mechanical coupling means for temporary attachment to a powered implement with a fluid delivery source;
said powered implement with a first controller means for said spin-revolution receptive means whereby said coupled fluid emitter can be spun around a central axis by the action of said first controller means;
said powered implement with a second controller means commanding offset axis displacement of said central axis of said fluid emitter.

2. A fluid emitter as in claim 1 with said first controller means of said powered implement a flywheel, and said spin-revolution receptive means of said fluid emitter a gear.

3. A fluid emitter as in claim 1 with said first controller means of said powered implement a variable field generator, and said spin-revolution receptive means of said emitter a magnetic band.

4. A fluid emitter as in claim 1 with magnetic elements; said second controller means of said powered implement a variable field generator maintaining a first magnetic field in operational proximity to a second magnetic field generated by said magnetic elements of said emitter.

5. A fluid emitter as in claim 1 with said second controller means of said powered implement a round bearing in contact with the lower rim of said emitter, said bearing with a travel path around said powered implement.

6. A fluid emitter as in claim 5 with said powered implement having third controller means configured to command the travel speed of said bearing.

7. A fluid emitter as in claim 1, wherein said offset axis displacement: is selected from circular means, elliptical means, and V-H coordinated means.

8. A fluid emitter as in claim 1 with said internal pressure generating means one or a plurality of displacement actuators in linear contact with said fluid.

9. A fluid emitter as in claim 1 with said plurality of exit-ports arranged whereby an individual first exit-port is further from said central spin axis of said emitter than a second exit-port closer to said central spin axis, with said first exit-port of greater diameter and greater length than the lesser diameter and lesser length of said second exit-port.

10. A fluid emitter as in claim 1 with said fluid containing reductive elements.

11. A pressurized fluid emitter for reducing the exposed surface of a solid substance, comprising: a main body portion containing a guidance channel for said pressurized fluid; said main body portion with spin-revolution receptive means; an anterior portion with one or a plurality of exit-ports connected to said channel for external discharge of said pressurized fluid; and a posterior portion containing coupling means for admission of an external source of said pressurized fluid to said channel; said posterior portion with an indented surface whereby external controller means when placed by an operator in close proximity to said indented surface command offset axis displacement of the revolution spin axis of said fluid emitter.

12. A fluid emitter as in claim 11, wherein said spin-revolution receptive means of said fluid emitter is selected from gear receptive means and magnetic band receptive means.

13. A fluid emitter as in claim 11 with said coupling means joined to an anchor stem device to admit said external source of said pressurized fluid to said channel; said anchor stem device containing said external controller means; wherein said external controller means is a member of the list of controller means types including round bearings and magnetic field generators.

14. A fluid emitter as in claim 11 with said fluid guidance channel fitted with pressure variance means whereby the first pressure value of said pressurized fluid within said pressure generating channel is altered up to a still greater second pressure value before said pressure variance means returns said pressure value down to said first pressure value.

15. A fluid emitter as in claim 14 with said pressure variance means the action of one or a plurality of displacement actuators in linear contact with said fluid.

16. A fluid emitter, including: one or a plurality of exit-ports for releasing said fluid; coupling means for receiving said fluid; internal pressure generating means for lifting the velocity of said fluid leaving said exit-ports; with control means for said pressure generating means to continually interrupt and reinitiate said lifting of said velocity of said fluid at a prescribed rate; spin-revolution receptive means for spinning said emitter around the central axis of said emitter at a regulated rate; with said one or said plurality of said exit-ports linearly placed at different locations from the location of said central axis.

17. A fluid emitter as in 16 with said control means arranged such that said prescribed rate is a value completing between two and twenty separate ejections of said fluid for each operational second of time; and with said regulated rate a number between six and thirty complete spins per second.

18. A fluid emitter as in claim 16, wherein said spin-revolution receptive means of said fluid emitter is selected from gear receptive means and magnetic band receptive means.

19. A fluid emitter as in claim 16 with said coupling means joined to an anchor stem device to direct said received fluid to said emitter; said anchor stem device containing spin controller means to engage said spin-revolution receptive means; whereas said spin controller means is selected from the two spin controller means types flywheels and magnetic field generators.

20. A fluid emitter as in 16 with said internal pressure generating means the action of one or a plurality of displacement actuators in linear contact with said fluid.
